(19) United States
(12) Patent Application Publication
(10) Pub. No.: US 2008/0036982 A1
(43) Pub. Date: Feb. 14, 2008

(54) Method For Structuring A Substrate Using Multiple Exposure

(75) Inventors: Ulrich Wegmann, Koenigsbronn (DE); Gerd Reisinger, Oberkochen (DE); Manfred Maul, Aalen (DE); Paul Graeupner, Aalen (DE); Martin Schriever, Aalen (DE); Aksel Goehnermeier, Aalen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/547,909

(22) PCT Filed: Apr. 11, 2005
(86) PCT No.: PCT/EP05/03780

§ 371 Date: Jul. 30, 2007

Related U.S. Application Data
(60) Provisional application No. 60/560,623, filed on Apr. 9, 2004.

(30) Foreign Application Priority Data
Apr. 23, 2004 (DE) 102004020983.9

(51) Int. Cl. G03B 27/42; G03B 27/52

(52) U.S. Cl. 355/44; 355/77

(57) ABSTRACT

1. Method for patterning a substrate using multiple exposure.

2.1. The invention relates to a method for patterning a substrate using exposure processes of an adjustable optical system, a multiple exposure being used for producing a structure image on the substrate.

2.2. According to the invention, for at least one of the plurality of exposures, the imaging quality of the optical system is determined by means of a respective measurement step and at least one parameter of the optical system that influences the imaging quality is set depending on this.

2.3. Use e.g. for the patterning of semiconductor wafers in microlithography projection exposure apparatuses.

The invention relates to a method for patterning a substrate using exposure processes of an adjustable optical system, a multiple exposure being used for producing a respective structure image on the substrate.

The priority of German patent application 10 2004 020 983.9 and U.S. patent application No. 60/560,623 is claimed for the present application, and, in order to avoid unnecessary text repetitions, the contents of said patent applications in their entirety are hereby incorporated by reference herein.

Methods for patterning a substrate using exposure processes are known in a variety of embodiments and are used for example for wafer patterning in the production of semiconductor components using a microlithography projection exposure apparatus. Such apparatuses typically comprise an illumination system and a projection objective disposed downstream. At the illumination system, it is possible to perform different illumination settings, such as conventional illumination with a variable degree of coherence, annular field illumination, dipole or quadrupole illumination, etc., which are also referred to as illumination settings. The radiation made available by the illumination system illuminates as homogenously as possible an illumination field into which a reticle/mask structure can be introduced, preferably in an object plane of the projection objective, in order to be imaged by the latter onto a light-sensitive layer and to produce there a structure image corresponding to the mask structure.

In this case, it is known e.g. from the published patent application US 2004/0059444 A1, for wafer patterning by means of a microlithography projection exposure apparatus, to determine imaging aberrations of the optical system by means of a respective measurement step using a wavefront measurement method and to set at least one aberration-influencing parameter of the optical system depending on this.

For the structure exposure of the light-sensitive layer, the exposure intensity profile in the depth direction and the lateral direction of the layer is often of major importance. Said profile depends on the exposure parameters. A significant influencing factor is the nominal aperture angle of the radiation impinging on the light-sensitive layer, said angle primarily being determined by the numerical aperture of the imaging system, which can be set e.g. by means of a variable aperture diaphragm at the illumination system and/or at the projection objective of a microlithography projection exposure apparatus. Further influencing factors are the illumination setting and the aberrations of the imaging system. By way of example, during the structure exposure of a photoresist layer on a wafer, the exposure intensity profile has a great influence on the attainable profile of the exposed and developed resist layer. In this case, resist sidewalls that are as steep as possible are usually desired, which necessitates exposure through the resist layer as uniformly as possible in the depth direction in conjunction with an as far as possible constant fully exposed layer width of the structure elements.

It is known, for the purpose of producing the structure image in the light-sensitive layer, to carry out a plurality of exposures with different mask structures at different numerical apertures and/or illumination settings or with laterally displaced mask structures, such as for optical proximity correction or for increasing the structure resolution, see e.g. the journal papers M. Fritze et al., “Limits of Strong Phase Shift Patterning for Device Research”, Proceedings of SPIE, volume 5040, page 327, and T. Ebihara et al., “Beyond k₁=0.25 lithography: 70 nm L/S patterning using KrF scanners”, Proceedings of SPIE, vol. 5256, page 985. A scanning double exposure method is described in the published patent application US 2002/0014600 A1.

The technical problem on which the invention is based is to provide a method of the type mentioned in the introduction which permits, with relatively low outlay, a high quality of a structure image on the substrate, such as a uniform exposure through a light-sensitive layer in the depth, and in specific cases reduces the exposure steps necessary for producing the structure image.

The invention solves this problem by providing a method having the features of claim 1. In the case of the method according to the invention, a multiple exposure is used for producing a respective structure image on the substrate, in which case, for at least one, e.g. for at least two or if necessary for all of the plurality of exposures, the imaging quality of the optical system is determined by means of a measurement step and at least one parameter of the optical system that influences the imaging quality is set depending on this. This permits for example a structure exposure by multiple exposure at different illumination settings and diaphragm settings with optimized aberrations. In this case, the determination of the imaging quality in the measurement step encompasses both the case where the parameter(s) crucial for this purpose is (are) in each case currently detected, and the case where the imaging quality is predicted on the basis of the measurement results of the measurement step for the exposure to be carried out.

For the structure exposure, e.g., a predetermined structure, which may be formed by a reticle/mask structure irradiated with exposure radiation, is imaged onto a light-sensitive layer. In the case of a microlithography projection exposure apparatus, by way of example, the imaging of the structure is effected by the projection objective of said apparatus, it being possible to implement illumination settings at the upstream illumination system in order to adapt the exposure radiation to the structure to be imaged. As a result of the multiple exposure during which at least two, and often all of the exposure processes are carried out with different parameters, such as different numerical apertures and/or illumination settings with optimized aberrations, the quality of the structure image can be improved. It is thus possible e.g. to perform a patterned pre-exposure of the light-sensitive layer with an increased depth of field. Different mask structures or the same mask structure can be used as required for the different exposures. In addition, it is also possible to vary the energy dose and further exposure parameters during the different exposures. Overall, the method thus enables a large bandwidth of exposure settings.

In one development of the method, the measurement step for at least one of the exposures is carried out directly prior to the exposure. The aberration behavior of the optical imaging system is thereby set directly prior to the exposure, so that even spontaneously occurring influences are taken into account in the aberration optimization.

In one refinement of the method, the measurement step for at least one of the exposures is carried out beforehand prior to the first exposure and the associated settings of the at least one aberration-influencing parameter are stored and are retrieved for carrying out the exposure. In this refinement of the method, a fast, aberration-optimized multiple exposure of the light-sensitive layer is possible since the relevant exposures are not interrupted by measurement steps.

In one development of the method, the setting of the at least one aberration-influencing parameter comprises a setting of one or a plurality of adjustable optical elements, such as lenses, and/or an entrance focal distance of the optical imaging system. Adjustable lenses e.g. in objectives can be influenced externally, e.g. by means of manipulators, in terms of their imaging properties with corresponding effects on the aberrations of the imaging system. The so-called entrance focal distance, that is to say the position of a reticle/mask structure to be imaged in the (z) direction parallel to the beam path, can likewise be adjusted for aberration optimization. When the entrance focal distance is changed, the focus, that is to say the image plane position in the z direction, is correspondingly readjusted.

In one refinement of the method, the measurement step(s) is (are) carried out by a method based on point diffraction interferometry, shearing interferometry, Fizeau interferometry, Twyman-Green interferometry or Shack-Hartmann interferometry. The aforementioned methods represent typical methods used for the interferometric measurement of wavefronts.

A method developed according to the invention is carried out for the photoresist exposure on a wafer using a microlithography projection exposure apparatus as adjustable optical imaging system.

In further advantageous refinements of the method according to the invention, the multiple exposure comprises at least two exposure processes with different settings, for which purpose one or a plurality of the parameters of field size, field position, degree of polarization, polarization direction of the illumination radiation, illumination direction or coherence of the illumination radiation, numerical aperture of the optical system, such as of a projection objective, and wavelength of the imaging radiation are changed as required.

In one refinement of the invention, a partial patterning of the substrate is carried out between two exposure processes of the multiple exposure.

In a further refinement of the invention, depending on the application, the measurement step involves determining, that is to say currently measuring and/or predicting, one or a plurality of the following parameters indicative of the imaging quality: aberrations of the optical system, such as of a projection objective, in which case polarized radiation, in particular, may also be used for measuring the aberrations, variation of the illumination intensity over the imaging field used, variation of the illumination intensity over the set illumination directions, variation of the degree of polarization of the illumination over the imaging field used, variation of the polarization direction of the illumination over the imaging field used, variation of the degree of polarization of the illumination over the set illumination directions, variation of the polarization direction of the illumination over the set illumination directions, position fidelity of the imaging, best setting plane of the imaging, wavelength of the imaging radiation and proportion of extraneous or scattered light in the imaging radiation.

In further refinements of the invention, the setting of the at least one parameter that influences the imaging quality comprises the setting of at least one transmission filter element in at least one field and/or pupil plane and/or the setting of at least one polarization-influencing filter element in at least one field and/or pupil plane.

In a further refinement of the invention, the setting of the parameter(s) influencing the imaging quality comprises an optimization of the imaging quality in the imaging field used with the aid of the position of the imaging field in the overall useable imaging region and/or with the aid of the size of the imaging field, it being possible to restrict the size of the imaging field along the scanning direction in the case of a scanning exposure method, an optimization of the imaging quality by means of a positioning of the substrate to be exposed perpendicular and/or parallel to the optical axis of the system and/or an optimization of the imaging quality by means of exchanging optically effective elements of the system.

Advantageous exemplary embodiments of the invention are illustrated in the drawings and are described below. In the figures:

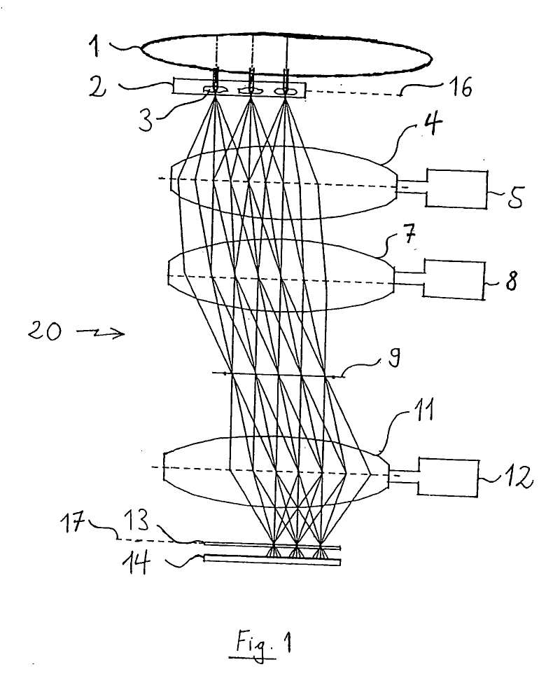

FIG. 1 shows a schematic side view of a projection part of an adjustable microlithography projection exposure apparatus with an integrated device for wavefront measurement,

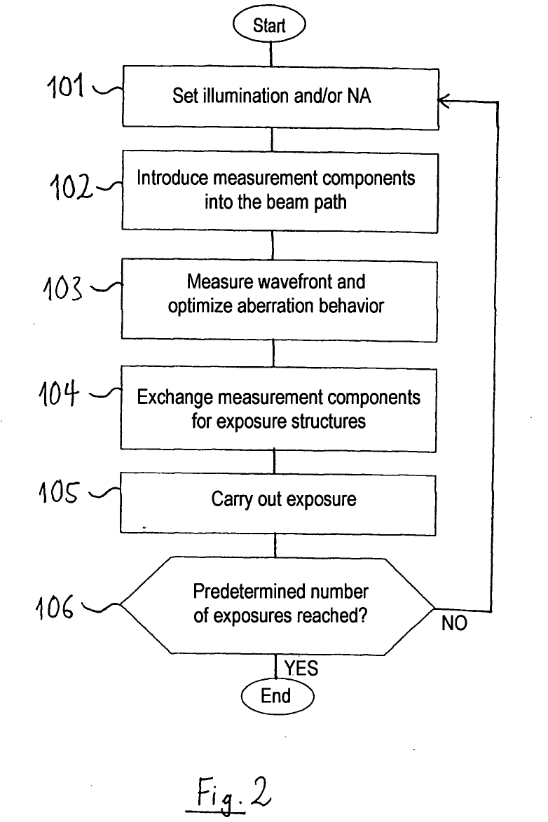

FIG. 2 shows a flow chart of a method for the structure exposure of a light-sensitive layer by means of the exposure apparatus from FIG. 1,

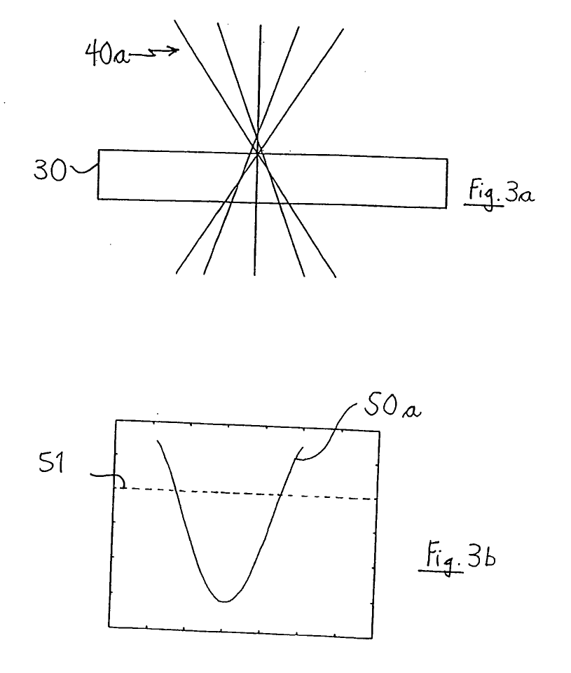

FIGS. 3a and 3b show a schematic side view of a beam path through a light-sensitive layer exposed e.g. by means of the exposure apparatus in accordance with FIG. 1 and, respectively, a diagram of an associated wavefront aberration profile at a first, low set numerical aperture of the imaging system without aberration optimization,

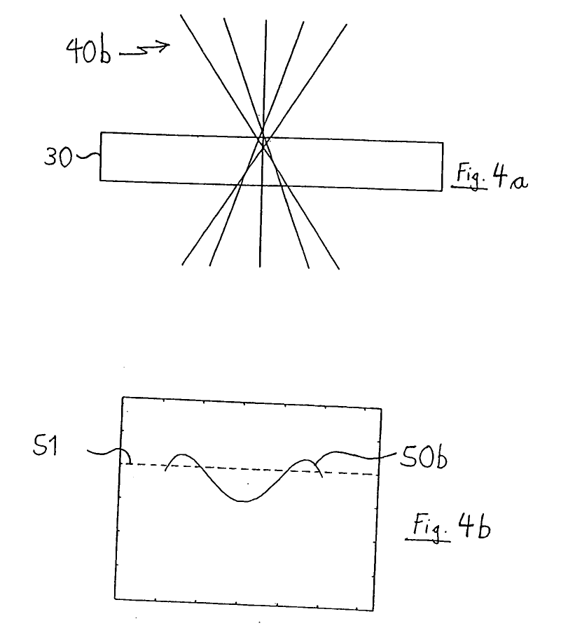

FIGS. 4a and 4b show views corresponding to FIGS. 3a and 3b, respectively, with aberration optimization, and

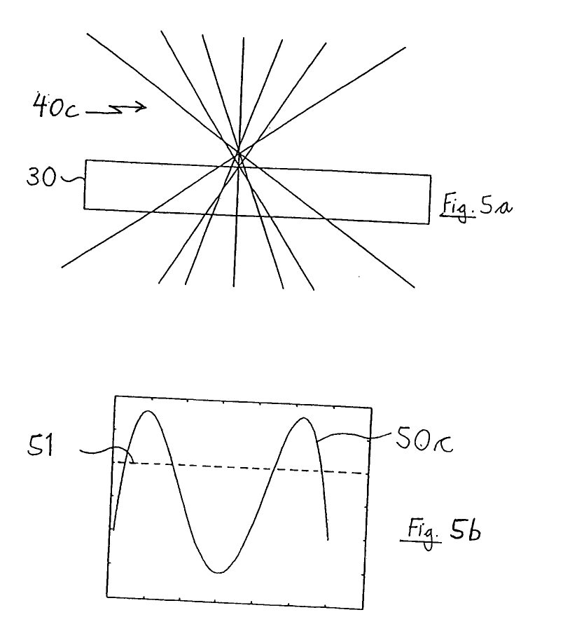

FIGS. 5a and 5b show views corresponding to FIGS. 3a and 3b, respectively, for a second, higher set aperture.

The multiple exposure method according to the invention is suitable for the structure exposure of a light-sensitive layer using an arbitrary adjustable optical imaging system, as an example of which FIG. 1 schematically shows a microlithography projection exposure apparatus for wafer exposure with a projection objective 20 of customary design serving as projection part. Disposed upstream of the projection objective 20 is an illumination system of customary design, of which only a field lens 1 is shown in a representative manner in FIG. 1 and which provides an illumination radiation that is used both for exposure processes and for wavefront measurement processes. Three lenses 4, 7, 11 of the projection objective 20 are shown as representatives of a plurality of imaging-active optical components thereof. With assigned lens manipulators 5, 8, 12, it is possible to influence the positioning of the lenses 4, 7, 11, e.g. in order to improve the aberration behavior of the projection objective 20. An aperture diaphragm 9 is provided in the projection objective 20 for the purpose of adapting the input-side numerical aperture thereof to a set output-side numerical aperture of the illumination system 1.

For carrying out wavefront measurements of the projection objective 20, a wavefront measurement device of the type of a multichannel shearing interferometer is integrated into the exposure apparatus. Said device comprises, as shown in FIG. 1, a measurement structure unit 2 positioned on the object side in or near an object plane 16 of the projection objective 20, and also a diffraction grating 13 positioned on the image side in or near an image plane 17 of the projection objective 20. The measurement structure unit 2 has a plurality of measurement structures 3 for producing a plurality of wavefronts, so that a simultaneous wavefront measurement can be carried out at a plurality of regions of the field of the objective 20. An interference pattern generated by the diffraction grating 13 is detected by a downstream detector unit 14, e.g. a CCD camera. The measurement structure unit 2, the diffraction grating 13 and the detector unit 14 are configured such that they can be brought into and out of the beam path of the projection objective 20 in exchange for units used in exposure operation, such as reticles or reticle holders and wafers or wafer holders, or are integrated into these. This enables a wavefront measurement of the projection objective 20 in situ, that is to say in the installation state in the microlithography projection exposure apparatus.

FIG. 2 illustrates, in a flow chart, a method realization that can be implemented using the exposure apparatus from FIG. 1 for the exposure e.g. of a photoresist layer on a semiconductor wafer by means of multiple exposure with different exposure parameters and respective wavefront measurement processes between the individual exposures for aberration optimization. In a setting step 101, for this purpose a first illumination setting is effected at the illumination system and an output-side numerical aperture (NA) of the illumination system is set to a low value of e.g. NA=0.5. The input-side numerical aperture of the projection objective 20 is adapted to the numerical aperture of the illumination system by setting of its aperture diaphragm 9.

In a subsequent method step 102, the measurement components are introduced into the beam path of the projection objective 20, in particular the measurement structure unit 2, the diffraction grating 13 and the detector unit 14. In a next step 103, a wavefront measurement is then carried out and the aberration behavior of the projection objective is determined. For this purpose, as indicated by the beam path shown in FIG. 1, a wavefront generated by the respective measurement structure 3 or the respective field region in the object plane 16 is emitted and it passes through the projection objective 20 and converges at a corresponding point on the diffraction grating 13 positioned in the image plane 17. An interference pattern generated thereby is detected by the downstream detector unit 14. In accordance with the technique of lateral shearing interferometry, the measurement structure unit 2 and the diffraction grating 13 are progressively displaced relative to one another laterally along a periodicity direction of the diffraction grating 13, the associated interference pattern being detected in each case. The wavefront gradient can be determined from the interference patterns, and from said wavefront gradient it is possible to reconstruct the wavefront with a desired spatial resolution that describes the aberration behavior of the projection objective 20 e.g. in a pupil plane.

Instead of a lateral shearing interferometry technique, other wavefront measurement methods are also suitable for determining the aberration behavior of the projection objective 20, e.g. point diffraction interferometry, Fizeau interferometry, Twyman-Green interferometry or Shack-Hartmann interferometry.

The determined aberration behavior of the projection objective 20 is then corrected or optimized in a desired manner by corresponding adjustment of the adjustable lenses 4, 7, 11 by means of the lens manipulators 5, 8, 12. As an alternative or in addition, the entrance focal distance of the projection objective 20 may also be set for the same purpose, the focus position in the z direction, that is to say in the direction parallel to the optical axis or to the beam path, simultaneously being set in such a way that the projection objective 20 still remains focused onto the image plane.

The effect of the optimization of the aberration behavior during method step 103 described above on the exposure of a light-sensitive layer is illustrated in FIGS. 3 and 4. FIG. 3a shows a schematic side view of a non-aberration-optimized beam profile 40a upon passing through a light-sensitive layer 30 for the case of a low numerical aperture set of e.g. NA=0.5. FIG. 4a shows an aberration-optimized beam profile 40b for an identical numerical aperture. An aberration curve 50a measured in the case of the non-optimized beam profile 40a is schematically plotted as a function of location in FIG. 3b. A corresponding aberration curve 50b obtained after the aberration correction has been carried out is illustrated in FIG. 4b with the same scale as in FIG. 3b. It can clearly be discerned that the non-corrected aberration curve 50a fluctuates about a zero line 51, at which no aberrations are present, to a significantly greater extent than the corrected aberration curve 51b. In the example shown, the wavefront is optimized in particular with regard to spherical Zernike coefficients or to a minimum rms value. Of course, the aberration behavior of the projection objective 20 can also be corrected with regard to other aberration contributions or Zernike coefficients, as required.

The effect of the aberration correction also becomes clear when the non-aberration-corrected beam profile 40a is compared with the corrected beam profile 40b. In the former beam profile the location of the minimum beam cross section is situated before the light-sensitive layer 30, and in the latter beam profile said location is situated within the light-sensitive layer 30. As a result, the illumination intensity of the corrected beam profile 40b is concentrated onto a smaller partial region of the layer 30 than in the uncorrected case. This enables more uniform exposure through the layer 30 in the depth direction and, as a result, e.g. in the case of a resist layer, makes it possible to obtain steeper sidewalls of the resist material remaining after development.

After the optimization of the aberration behavior, in a next method step 104 of FIG. 2, the mask unit 2, the deflection grating 13 and the detector unit 14 are exchanged for a structure to be imaged (exposure mask or reticle/mask structure) and a substrate with a light-sensitive layer (photoresist on wafer), in order to prepare a subsequent exposure. In a subsequent step 105, the first exposure of the light-sensitive layer is performed by imaging the mask structure onto the photoresist by means of the projection objective 20. In a method step 106, a check is then made to ascertain whether a number of exposures that is required for producing a desired quality of the structure image on the photoresist and is typically defined beforehand prior to carrying out the method has been reached.

If this is the case, the method is ended. Otherwise, steps 101 to 105 are repeated until the required number of exposures has been reached. In the repetition of method step 101, a new illumination setting and/or a new numerical aperture are set and, in the repetition of step 102, prior to introducing the measurement components, firstly the reticle and wafer are removed from the beam path. Depending on the application, the repeated exposure steps are carried out with different mask structures or the same mask structure.

A second exposure may be carried out for example with an altered numerical aperture with respect to the first exposure, e.g. with a maximum numerical aperture of 0.8. A corresponding beam profile 40c with a significantly increased aperture angle in comparison with FIGS. 3a and 4a is shown in FIG. 5a. An aberration curve 50c assigned to the aberration-optimized beam profile of FIG. 5a is illustrated in FIG. 5b. It may alternatively be desirable to carry out the present exposure step or one of the other exposure steps with a non-optimized beam profile. Moreover, the sequence of exposure steps need not necessarily take place from smaller to larger numerical apertures. Thus, the exposure step where NA=0.8 may also take place prior to the exposure step where NA=0.5, by way of example, in order to produce a wide pre-exposure.

During the multiple exposure with different numerical apertures, it is possible, as mentioned, to use a plurality of different reticle/mask structures in a manner known per se, e.g. in order to achieve an optical proximity correction. This makes use of the fact that during a first exposure with a small numerical aperture, a patterned pre-exposure of the substrate or resist with an increased depth of field is achieved before a second exposure with a higher numerical aperture and lower depth of field is carried out, with the result that it is possible to achieve a uniform exposure through the resist layer in the depth direction. The number of exposures required for producing a desired structure image and/or the number of different masks can be reduced, if appropriate, by the optimization of the aberration behavior of the projection objective for some or all of the exposures by means of the method described above.

As an alternative to the method example described above, a method variant is also possible in which the measurement steps for the relevant exposures are carried out beforehand prior to the first exposure and the settings determined in a manner dependent thereon at the imaging system used for producing an optimized aberration behavior are stored in order to retrieve these settings when carrying out the relevant exposure, so that a fast, aberration-optimized multiple exposure can be carried out. In simplified embodiments of the invention, the measurement step is not carried out for all of the plurality of exposures, but rather only for a portion thereof, in the extreme case only for one of the exposures.

In the above-described and further exemplary embodiments according to the invention, it is possible, for optimizing the imaging quality, to change in particular one or a plurality of the parameters of field size, polarization and wavelength between at least two exposure processes of the multiple exposure. Thus, by stopping down and/or repositioning the effectively active field region, that is to say by changing the field size and/or the field position, it is possible to mask out field regions for which undesirable, inadequately correctable aberrations have been determined. Moreover, the influence of scattered light on the exposure process can be corrected or influenced in this way. By changing the degree of polarization and/or the polarization direction of the imaging radiation, it is possible to counteract additional image errors and transmission changes in the sense of a loss of uniformity. By altering the wavelength and in particular the bandwidth of the imaging radiation, it is possible in some cases to obtain an increase in the depth of field provided that possibly accompanying contrast reductions are acceptable. It may concomitantly be expedient to restrict the field size in order to minimize chromatic transverse aberrations, that is to say CHV components.

A partial patterning of the exposed substrate may also be performed as required between two exposure processes of the multiple exposure. Thus, e.g. in the case of a double exposure method according to the so-called split pitch technique, an increase in the resolving power is achieved by virtue of the fact that after a first exposure, the resist is developed and a first structure is transferred into the underlying substrate, and afterwards the substrate is coated anew with resist and exposed again in order then to transfer a second structure information item into the same layer of the substrate.

In general, in particular the parameters of uniformity, ellipticity, polarization, focus, overlay and scattered light can also be measured and/or influenced in accordance with the invention. Uniformity is a measure of the uniform illumination of the region used for imaging. Ellipticity specifies the measure of uniform illumination of the illumination pupil. Degree of polarization and polarization direction and the variation thereof over the imaging field used likewise affect the imaging quality, as is known. Focus specifies the position of the best setting plane along the optical axis of the optical system used. The overlay parameter specifies the positioning accuracy, which may vary both between different settings and between different structures to be exposed. Scattered light that does not contribute to the imaging may cause contrast losses, on the one hand, but on the other hand also variations of the structure width over the field used.

1. A method for patterning a substrate using exposure processes of an adjustable optical system, comprising:
a multiple exposure being used for producing a structure image on the substrate,
for at least one of the plurality of exposures, the imaging quality of the optical system is determined by means of a respective measurement step and at least one parameter of the optical system that influences the imaging quality is set depending on this.

2. The method as claimed in claim 1, wherein the measurement step for at least one of the exposures is carried out directly prior to the exposure.

3. The method as claimed in claim 1, wherein the measurement step for at least one of the exposures is carried out beforehand prior to the first exposure and the associated settings of the at least one parameter that influences the imaging quality are stored in retrievable fashion and are retrieved when carrying out the relevant exposure.

4. The method as claimed in claim 1, wherein the setting of the at least one parameter that influences the imaging quality in respect of aberration comprises a setting of one or a plurality of adjustable optical elements and/or an entrance focal distance of the system.

5. The method as claimed in claim 1, wherein the respective measurement step is carried out by a method based on point diffraction interferometry, shearing interferometry, Fizeau interferometry, Twyman-Green interferometry or Shack-Hartmann interferometry.

6. The method as claimed in claim 1, wherein it is carried out for the structure exposure of a photoresist layer on a semiconductor wafer using a microlithography projection exposure apparatus as adjustable optical imaging system.

7. The method as claimed in claim 1, wherein the setting of the at least one parameter that influences the imaging quality comprises a setting of at least one variable parameter from a group comprising the parameters of degree of polarization of an illumination used for the exposure, polarization direction of the illumination, numerical aperture of at least one component of the optical system, illumination direction and wavelength of the imaging radiation, after at least one exposure process of the multiple exposure.

8. The method as claimed in claim 1, wherein a partial patterning of the substrate is carried out between at least two exposure processes of the multiple exposure.

9. The method as claimed in claim 1, wherein the measurement step involves determining one or a plurality of parameters indicative of the imaging quality of the optical system from a parameter group comprising the parameters of aberrations of at least one optical component of the optical system, variation of the illumination intensity over an imaging field used, variation of the illumination intensity over set illumination directions, variation of an illumination degree of polarization over the imaging field used, variation of the illumination polarization direction over the imaging field used, variation of the illumination degree of polarization over the set illumination directions, variation of the illumination polarization direction over the set illumination directions, position fidelity of the imaging, best setting plane of the imaging, wavelength of the imaging radiation and scattered light proportion of the imaging radiation.

10. The method as claimed in claim 9, wherein polarized radiation is used for determining the aberrations.

11. The method as claimed in claim 1, wherein the setting of the at least one parameter that influences the imaging quality comprises a setting of at least one transmission filter element in at least one field and/or pupil plane and/or a setting of at least one polarization-influencing filter element in at least one field and/or pupil plane of the optical system.

12. The method as claimed in claim 1, wherein the setting of the at least one parameter that influences the imaging quality comprises an optimization of the imaging quality in the imaging field used with the aid of the position of the imaging field in the useable imaging region and/or the size of the imaging field and/or an optimization of the imaging quality by means of a positioning of the substrate to be exposed perpendicular and/or parallel to the optical axis and/or an optimization of the imaging quality by means of exchanging one or a plurality of optically effective elements of the optical system.

13. The method as claimed in claim 12, wherein the optimization of the imaging quality using the size of the imaging field comprises a limitation of the size of the imaging field along a scanning direction of an optical system that effects scanning exposure.
